(19) United States
(12) Patent Application Publication
(10) Pub. No.: US 2010/0283941 A1
(43) Pub. Date: Nov. 11, 2010

(54) LIQUID CRYSTAL DISPLAY PANEL, LIQUID CRYSTAL DISPLAY DEVICE AND MANUFACTURING METHOD OF LIQUID CRYSTAL DISPLAY PANEL

(76) Inventors: Tadashi Nemoto, Osaka (JP); Seishi Kosegawa, Osaka (JP); Naru Usukura, Osaka (JP); Takehiro Murao, Osaka (JP); Satoshi Shibata, Osaka (JP); Takuma Tomotoshi, Osaka (JP)

Correspondence Address: NIXON & VANDERHYE, PC, 901 NORTH GLEBE ROAD, 11TH FLOOR, ARLINGTON, VA, 22203, US

(21) Appl. No.: 12/809,761

(22) PCT Filed: Dec. 12, 2008
(86) PCT No.: PCT/JP2008/003744

§ 371 Date: Jun. 21, 2010

(30) Foreign Application Priority Data
Dec. 21, 2007 (JP) 2007-330677

(51) Int. Cl. G02F 1/1335

(52) U.S. Cl. 349/63; 349/96; 349/117; 349/95

(57) ABSTRACT

A vertically aligned type liquid crystal display panel with wide viewing angles and high display quality can be provided with high production efficiency.

A liquid crystal display panel of the present invention includes: a liquid crystal layer of a vertically aligned type; a light-incident side substrate and a light-outgoing side substrate which oppose each other via the liquid crystal layer; a microlens array provided on a light-outgoing side of the light-outgoing side substrate, which includes a plurality of microlenses; an optical film which includes a first polarizing plate provided on a light-outgoing side of the microlens array; and an optical film which includes a second polarizing plate provided on a light-incident side of the light-incident side substrate.

### TECHNICAL FIELD

The present invention relates to a liquid crystal display panel and a liquid crystal display device, and more particularly to a liquid crystal display panel and a liquid crystal display device which include a microlens array.

### BACKGROUND ART

In recent years, liquid crystal display devices are widely used as display devices for monitors, projectors, mobile information terminals, mobile phones, and the like. Generally speaking, a liquid crystal display device allows the transmittance (or reflectance) of a liquid crystal display panel to vary with a driving signal, thus modulating the intensity of light from a light source for irradiating the liquid crystal display panel, whereby images and text characters are displayed. Liquid crystal display devices include direct-viewing type display devices in which images or the like that are displayed on the liquid crystal display panel are directly viewed, projection-type display devices (projectors) in which images or the like that are displayed on the display panel are projected onto a screen through a projection lens in an enlarged size, and so on.

By applying a driving voltage which corresponds to an image signal to each of the pixels that are in a regular matrix arrangement, a liquid crystal display device causes a change in the optical characteristics of a liquid crystal layer in each pixel, and regulates the transmitted light in accordance with the optical characteristics of the liquid crystal layer with polarizers (which typically are polarizing plates) being disposed at the front and rear thereof, thereby displaying images, text characters, and the like. In the case of a direct-viewing type liquid crystal display device, these polarizing plates are usually directly attached to a light-entering substrate (the rear substrate) and a light-outgoing substrate (the front substrate or viewer-side substrate) of the liquid crystal display panel.

Methods for applying an independent driving voltage for each pixel include a passive matrix type and an active matrix type. Among these, on a liquid crystal display panel of the active matrix type, switching elements and wiring lines for supplying driving voltages to the pixel electrodes need to be provided. As switching elements, non-linear 2-terminal devices such as MIM (metal-insulator-metal) devices and 3-terminal devices such as TFT (thin film transistor) devices are in use.

On the other hand, in a liquid crystal display device of the active matrix type, when strong light enters a switching element (in particular a TFT) which is provided on the display panel, its element resistance in an OFF state is decreased, thereby allowing the electric charge which was charged to the pixel capacitor under an applied voltage to be discharged, such that a predetermined displaying state cannot be obtained. Thus, there is a problem of light leakage even in a black state, thus resulting in a decreased contrast ratio.

Therefore, in a liquid crystal display panel of the active matrix type, in order to prevent light from entering the TFTs (in particular channel regions), a light shielding layer (called a black matrix) is provided on a TFT substrate on which the TFTs and the pixel electrodes are provided, or on a counter substrate that opposes the TFT substrate via the liquid crystal layer, for example.

In a reflection-type liquid crystal display device which performs displaying by reflecting light incident on the display surface from the viewer side, decrease in the effective pixel area can be prevented by utilizing electrodes as a reflection layer. However, in a liquid crystal display device which performs displaying by utilizing transmitted light, providing TFTs, gate bus lines, source bus lines, and a light shielding layer, which do not transmit light, will allow the effective pixel area to be decreased, thus resulting in a decrease in the ratio of the effective pixel area to the total area of the displaying region, i.e., the aperture ratio.

Liquid crystal display devices are characterized by their light weight, thinness, and low power consumption, and therefore are widely used as display devices of mobile devices such as mobile phones and mobile information terminals. With a view to increasing the amount of displayed information, improving the image quality, and so on, there are stronger and stronger desires for display devices to have higher resolutions. Conventionally, it has been a standard to adopt QVGA displaying by 240×320 pixels for liquid crystal display devices of the 2 to 3-inch class, for example, but devices which perform VGA displaying by 480×640 pixels have also been produced in the recent years.

As liquid crystal display panels become higher in resolution and smaller in size, the aforementioned decrease in their aperture ratio presents a greater problem. The reason is that, even if there is a desire to reduce the pixel pitch, constraints such as electrical performance and fabrication techniques make it impossible for the TFTs, the bus lines, etc., to become smaller than certain sizes. It might be possible to enhance the brightness of the backlight in order to compensate for the decreased transmittance, but this will induce an increased power consumption, thus presenting a particular problem to mobile devices.

In recent years, as display devices of mobile devices, transflective-type (reflection-transmission type) liquid crystal display devices which perform displaying by utilizing light from a backlight under dark lighting and perform displaying by reflecting light entering the display surface of the liquid crystal display panel under bright lighting have become prevalent. In a transflective-type liquid crystal display device, a region (reflection region) which performs displaying in the reflection mode and a region (transmission region) which performs displaying in the transmission mode are included in each pixel. Therefore, reducing the pixel pitch will significantly lower the ratio of the area of transmission region to the total area of the displaying region (aperture ratio of the transmission region). Thus, although transflective-type liquid crystal display devices have the advantage of realizing displaying with a high contrast ratio irrespective of the ambient brightness, they have a problem in that their brightness is lowered as the aperture ratio of the transmission region becomes smaller.

As a method for improving the efficiency of light utility of such a liquid crystal display device including transmission regions, Patent Document 1 discloses a method of providing microlenses for converging light in each pixel on the liquid crystal display device in order to improve the effective aperture ratio of the liquid crystal display panel.

Patent Document 2 discloses a liquid crystal display device which includes a microlens on the light-outgoing side of a liquid crystal display panel in order to widen the viewing angles of a TN (Twisted Nematic) type liquid crystal display device in which the liquid crystal is oriented horizontally to the substrate surface in the absence of an applied voltage. In this liquid crystal display device, the microlens is formed by curing a UV-curable resin in a mold.

Furthermore, the applicant discloses in Patent Document 3 a production method for a liquid crystal display panel with a microlens array, which is suitably used for transmission-type or transflective-type liquid crystal display devices and the like. According to the production method described in Patent Document 3, microlenses can be formed corresponding to the pixels in a self-aligning manner, with a high positional precision.

Patent Document 1: Japanese Laid-Open Patent Publication No. 5-188364

Patent Document 2: Japanese Laid-Open Patent Publication No. 8-76120

Patent Document 3: Japanese Laid-Open Patent Publication No. 2005-196139 (Japanese Patent No. 3708112).

### DISCLOSURE OF INVENTION

### Problems to be Solved by the Invention

The liquid crystal display device of Patent Document 1 includes microlenses on the light-incident side of the liquid crystal display panel with the view of improving the contrast. In this device, the microlenses are not used for the purpose of obtaining wide viewing angles. Note that, in this liquid crystal display device, an optical film, such as a polarizing plate, is placed closer to the liquid crystal layer side than the microlenses are.

The liquid crystal display device of Patent Document 2 is a TN-type liquid crystal display device, in which the microlens for diffusing outgoing light is provided on the light-outgoing side of the liquid crystal display panel. However, this microlens has a plurality of convex surfaces protruding toward the light-incident surface side and a plurality of flat areas formed between the convex surfaces in order to prevent scattering and refraction on the lens surface so that total reflection of light incoming from the outside can be reduced, and in order to decrease the distance between the lens surface and the liquid crystal display panel so that display blurriness can be prevented. Further, to secure the microlens, the gap between the microlens and the liquid crystal display panel is filled with an adhesive.

To realize such a configuration, the microlens of Patent Document 2 need to be formed by curing a UV-curable resin in a mold. Therefore, in this liquid crystal display device, it is difficult to form the microlens using a self-alignment method as described in Patent Document 3. Accordingly, it is difficult to align the pixels and the microlens with high precision.

Generally speaking, VA-type (vertically aligned type) liquid crystal display devices have higher viewing angle characteristics than TN-type liquid crystal display devices, and can realize still wider viewing angles and displaying of higher contrast by using optical films (polarizing plates and optical compensation elements) on both sides of VA-type liquid crystal display panels. Here, using the same element for both the incident-side optical film and the outgoing-side optical film is a common procedure, and this arrangement is capable of obtaining high optical compensation effects.

In a projection type display device such as a projector, there is a long distance from the device to the screen, and therefore high viewing angle characteristics are not required for the liquid crystal display panel. However, in a direct-viewing type liquid crystal display device used for mobile devices, digital still cameras, etc., high viewing angle characteristics are required. Therefore, in the case of a direct-viewing type liquid crystal display device which is not intended for use in a projection type display device, it might be conceivable to apply a VA-type liquid crystal display device. For an improved luminance, it might also be conceivable to adopt microlenses in such a VA-type liquid crystal display device. However, even if microlenses are to be adopted in a VA-type liquid crystal display device, no liquid crystal display panel construction has been realized that can achieve high levels of viewing angle characteristics. Also, no appropriate optical film arrangement in a VA-type liquid crystal display device to which a microlens is applied has been realized.

One of the objects of the present invention is to provide a direct-viewing type VA liquid crystal display panel with a microlens array which has small display unevenness and excellent viewing angle characteristics and which is capable of displaying with high luminance, and a liquid crystal display device which includes the liquid crystal display panel.

### Means for Solving the Problems

A liquid crystal display panel of the present invention includes: a liquid crystal layer of a vertically aligned type; a light-incident side substrate and a light-outgoing side substrate which oppose each other via the liquid crystal layer; a microlens array provided on a light-outgoing side of the light-outgoing side substrate; a first polarizing plate provided on a light-outgoing side of the microlens array; and a second polarizing plate provided on a light-incident side of the light-incident side substrate.

In one embodiment, the microlens array includes a plurality of microlenses formed by irradiating a photocurable resin through pixel apertures.

In one embodiment, the microlens array includes a plurality of microlenses which have convex surfaces on the light-outgoing side.

In one embodiment, the liquid crystal display panel is a direct viewing type liquid crystal display panel.

In one embodiment, the liquid crystal display panel further includes a viewing angle compensation plate.

In one embodiment, the viewing angle compensation plate is provided on the light-outgoing side of the microlens array.

In one embodiment, the viewing angle compensation plate is provided on the light-incident side of the microlens array.

In one embodiment, the first polarizing plate is provided on the light-outgoing side of the viewing angle compensation plate.

In one embodiment, a phase plate is provided on the light-outgoing side of the microlens array.

In one embodiment, the phase plate is provided between the viewing angle compensation plate and the first polarizing plate.

A liquid crystal display device of the present invention includes: the above-described liquid crystal display panel; and a backlight provided on the light-incident side of the liquid crystal display panel.

In one embodiment, the backlight includes a light guide plate configured to guide light emitted from a light source; a reflector configured to reflect the light originating from the light source toward the liquid crystal display panel; and a plurality of prisms of a reversed prism type which are provided between the light guide plate and the liquid crystal panel.

A liquid crystal display panel production method of the present invention includes the steps of: forming a microlens array on a light-outgoing side of a light-outgoing side substrate that opposes a light-incident side substrate via a vertically aligned type liquid crystal layer; placing a first polarizing plate on the light-outgoing side of the microlens array; and placing a second polarizing plate on a light-incident side of the light-incident side substrate.

In one embodiment, the microlens array is formed by irradiating a photocurable resin through pixel apertures.

In one embodiment, the microlens array is formed so as to have convex surfaces on the light-outgoing side.

In one embodiment, the method further includes the step of placing a viewing angle compensation plate.

In one embodiment, the viewing angle compensation plate is placed on the light-outgoing side of the microlens array.

In one embodiment, the viewing angle compensation plate is placed on the light-incident side of the microlens array.

In one embodiment, the method further includes the step of placing a phase plate on a light-outgoing side of the viewing angle compensation plate.

### Effects of the Invention

A liquid crystal display panel of the present invention is a vertically aligned type liquid crystal display panel in which microlenses are provided on the light-outgoing side of the light-outgoing side substrate. Thus, particularly excellent viewing angle characteristics can be obtained as compared with TN-type liquid crystal display panels and vertically aligned type liquid crystal display panels which do not include a microlens. In the liquid crystal display panel of the present invention, an optical film, such as a polarizing plate, or the like, is placed closer to the light-outgoing side than the microlenses are. Therefore, the distance between the liquid crystal layer and the microlenses can be decreased, and hence, clear displaying with small display blurriness can be provided. The exterior of the microlenses is covered with an optical film. Therefore, in a production process of the liquid crystal display panel and the liquid crystal display device, the microlenses are, advantageously, less likely to be scratched.

According to the present invention, the optical film, such as a polarizing plate, or the like, is placed closer to the light-outgoing side than the microlenses are. Further, the microlenses have convex surfaces protruding toward the light-outgoing side. Therefore, the microlenses can be formed in a self-aligning fashion. Thus, a liquid crystal display panel with high display quality in which the microlenses and the pixels are aligned with very high precision can be provided. The production process does not require aligning the microlenses and the pixels. Thus, the production cost can be reduced.

According to the liquid crystal display panel of the present invention, the optical film is provided on the light-outgoing side of the microlenses, and the microlenses have convex surfaces protruding toward the light-outgoing side. Thus, total reflection of external light which comes in the panel can be prevented, and high quality display can be provided even when the panel is used in an external light environment.

According to the present invention, the liquid crystal display device includes prisms of a reversed prism type between the light guide plate and the liquid crystal panel. Therefore, the amount of light which obliquely travels through the liquid crystal layer can be reduced. Thus, a whitening phenomenon, which would readily occur in the display of vertically aligned type liquid crystal display devices, can be reduced, so that decrease in the display quality can be prevented.

According to the present invention, a liquid crystal display panel and a liquid crystal display device with wide viewing angles in which the display unevenness and reflection of external light are reduced can be provided. Also, according to the present invention, the production efficiency of the liquid crystal display panel and the liquid crystal display device is improved, so that a liquid crystal display panel and the liquid crystal display device with high quality can be provided at low costs.

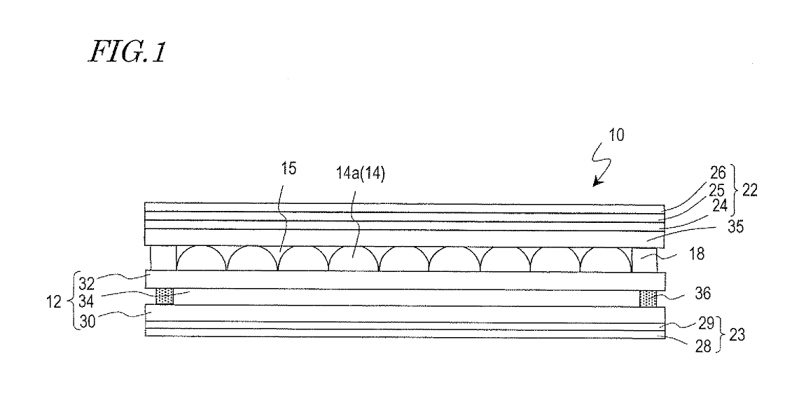

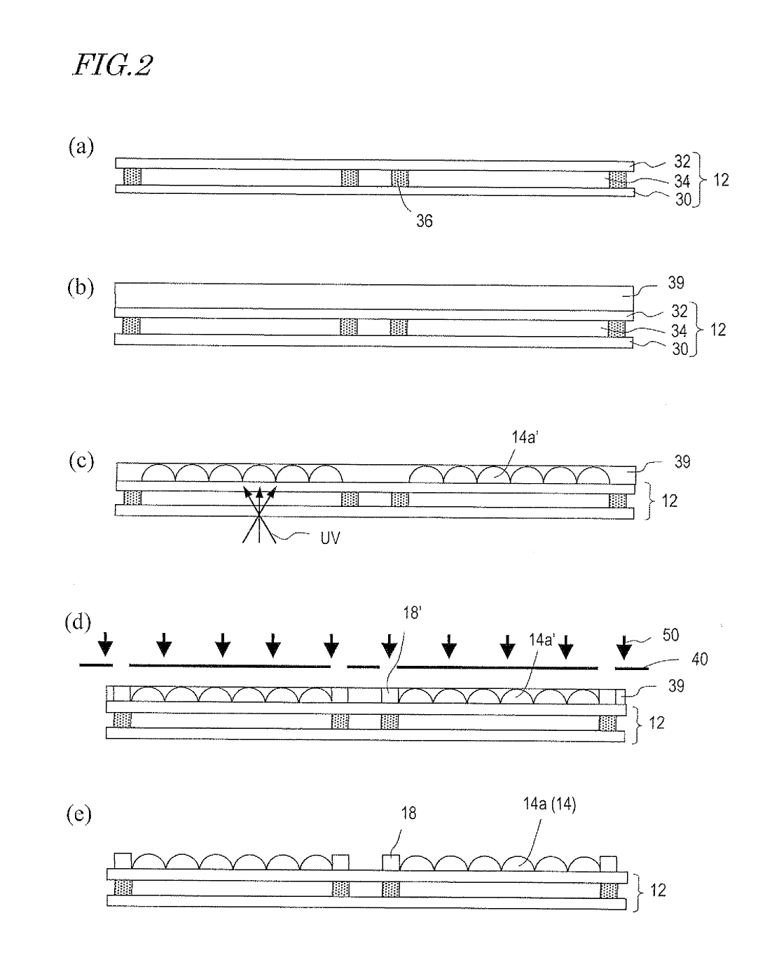

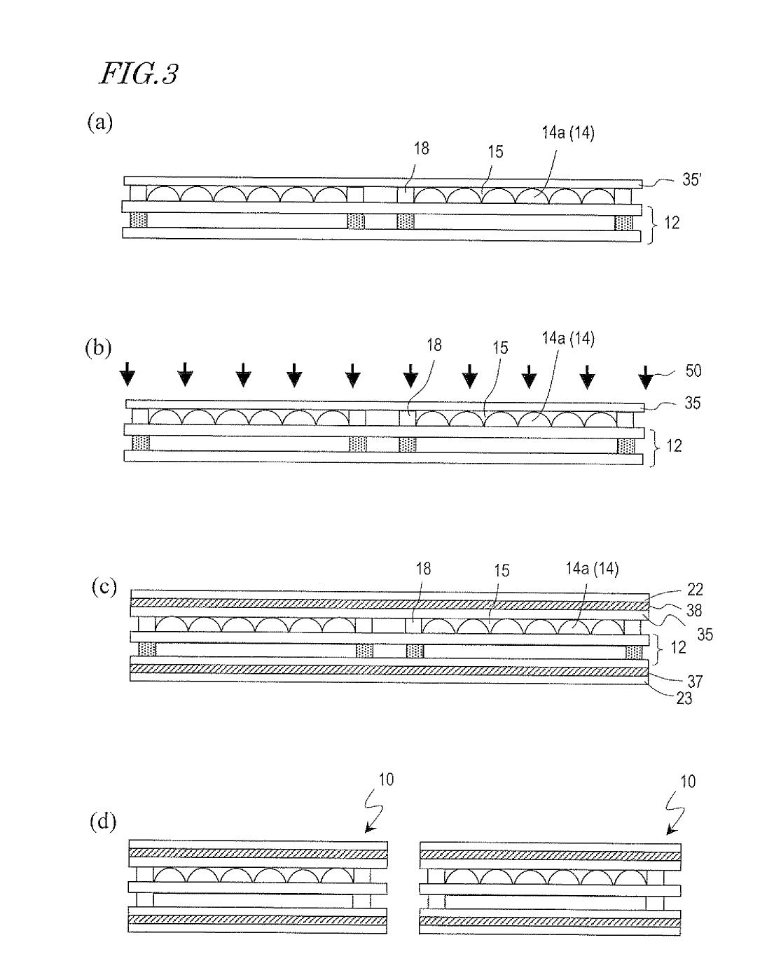

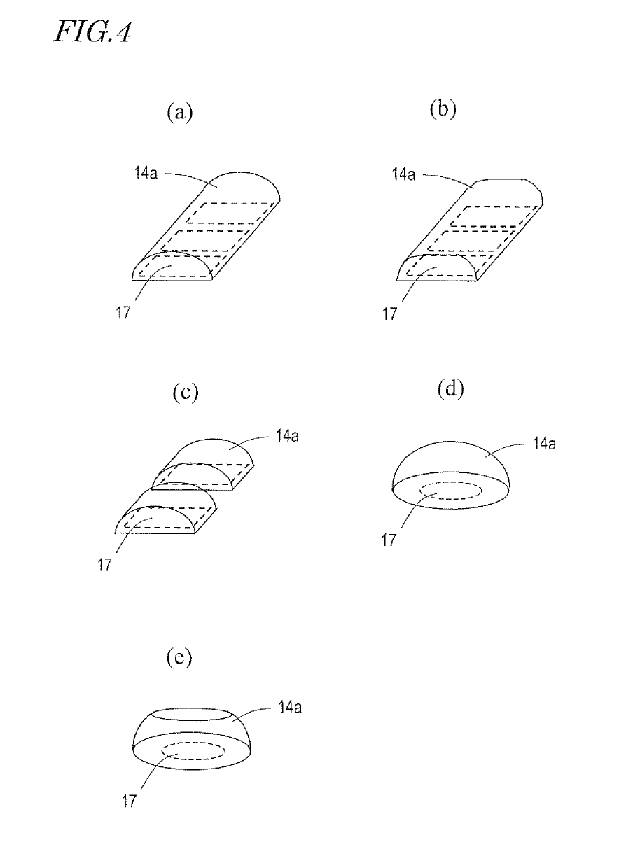

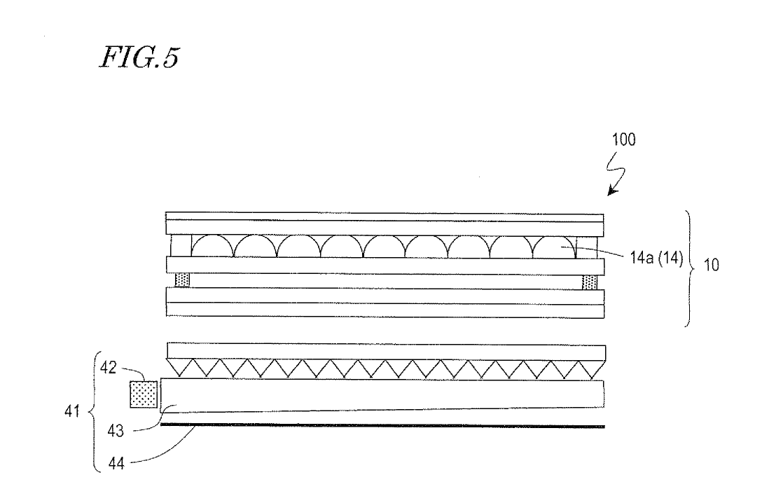

### BRIEF DESCRIPTION OF DRAWINGS

[FIG. 1] A cross-sectional view schematically showing a structure of a liquid crystal display panel of the present invention.

[FIG. 2] (a) to (e) are cross-sectional views schematically showing the first half of a production method of the present embodiment.

[FIG. 3] (a) to (d) are cross-sectional views schematically showing the second half of the production method of the present embodiment.

[FIG. 4] (a) to (e) are diagrams which show examples of the shape of a microlens which can be produced by the production method of the present embodiment.

[FIG. 5] A cross-sectional view schematically showing a liquid crystal display device which includes a liquid crystal display panel of the present invention.

### DESCRIPTION OF THE REFERENCE NUMERALS

10 liquid crystal display panel
12 liquid crystal panel
14 microlens array
14a microlens
14a′ latent image of microlens
15 gap
17 pixel aperture
18 support
18′ latent image of support
22, 23 optical film
24 viewing angle compensation plate
25 phase plate
26 polarizing plate
28 polarizing plate
29 phase plate
30 TFT substrate
32 counter substrate
34 liquid crystal layer
35 protection layer
35′ resin layer
36 sealant
37, 38 adhesive layer
39 resin layer
40 photomask
41 backlight
42 light source
43 light guide plate
44 reflector
50 UV light
100 liquid crystal display device

### BEST MODE FOR CARRYING OUT THE INVENTION

Hereinafter, a liquid crystal display panel embodiment of the present invention is described with reference to the drawings.

FIG. 1 is a cross-sectional view schematically showing a structure of a liquid crystal display panel 10 of the present embodiment. The liquid crystal display panel 10 is for use in a direct viewing type display device in which pictures displayed by the liquid crystal display panel 10 are directly viewed.

As shown in the drawing, the liquid crystal display panel 10 includes a liquid crystal panel 12 (also referred to as “liquid crystal cell”) which has a plurality of pixels in a matrix arrangement, a microlens array 14 which includes a plurality of microlenses 14a provided on the light-outgoing side of the liquid crystal panel 12 (the upper side of the drawing), supports 18 provided around the perimeter of the microlens array 14, a protection layer 35 provided on the light-outgoing side of the microlens array 14, an optical film 22 provided on the light-outgoing side of the protection layer 35, and an optical film 23 provided on the light-incident side of the liquid crystal panel 12 (the lower side of the drawing).

Here, the light-incident side of the liquid crystal display panel 10 refers to a side on which light originating from, for example, a backlight provided as a light source for transmissive display comes in. The light-outgoing side refers to a side on which the light goes out of the liquid crystal display panel 10 through a pixel aperture.

The microlens array 14 is herein made of a UV-curable acrylic resin with high visible light transmittance but may be made of, for example, a UV-curable or thermosetting epoxy resin. Each of the microlenses 14a of the microlens array 14 is a lenticular lens which covers a plurality of pixels, but may be a hemispherical microlens which corresponds to respective one of the pixels.

As will be described in more detail later, each of the microlenses 14a of the microlens array 14 has a convex surface protruding toward the light-outgoing side and is formed by irradiating a photocurable resin through a pixel aperture using a so-called self-alignment method.

The liquid crystal panel 12 includes a TFT substrate (light-incident side substrate) 30 which has pixel electrodes and switching elements, such as TFTs, for respective ones of the pixels, a counter substrate (light-outgoing side substrate) 32 which includes a color filter (CF) and a counter electrode, and a liquid crystal layer 34 interposed between the TFT substrate 30 and the counter substrate 32. The liquid crystal of the liquid crystal layer is tightly sealed between the TFT substrate 30 and the counter substrate 32 by a sealant 36 provided at the perimeter of the liquid crystal layer 34.

The liquid crystal layer 34 may be, for example, a vertically aligned type liquid crystal layer which includes a liquid crystal with negative dielectric anisotropy. Surfaces of the TET substrate 30 and the counter substrate 32 which are closer to the liquid crystal layer 34 are provided with unshown vertical alignment films. The vertical alignment films allow the liquid crystal to be oriented vertical to the substrate surface in the absence of an applied voltage between the pixel electrode and the counter electrode.

The protection layer 35 is secured by the supports 18. The protection layer 35 and the microlens array 14 are placed such that the protection layer 35 is in contact with the microlenses 14a only at and near their apexes. Between the microlens array 14 and the protection layer 35, there is a gap 15 which contains air. Note that an alternative configuration is possible in which the protection layer 35 is supported only by the supports 18 such that the microlenses 14a are not in contact with the protection layer 35. Still alternatively, the microlenses 14a may have protrusions at their apexes such that the protrusions are in contact with the protection layer 35.

The protection layer 35 is made of a UV-curable acrylic resin with high visible light transmittance as the microlens array 14 is. The protection layer 35 may also be made of a UV-curable or thermosetting epoxy resin. The protection layer 35 is preferably made of the same material as that of the microlenses 14a or a material which has a substantially equal refractive index to that of the material of the microlenses 14a. The supports 18 are also preferably made of the same material as that of the microlenses 14a. This can simplify the production process.

The optical film 22 includes a viewing angle compensation plate 24 which is adhered to the protection layer 35 via an unshown adhesive layer, a phase plate 25 which is adhered to the light-outgoing side of the viewing angle compensation plate 24, and a polarizing plate 26 which is adhered to the light-outgoing side of the phase plate 25. The optical film 23 includes a phase plate 29 which is adhered to the TFT substrate 30, and a polarizing plate 28 which is adhered to the light-incident side of the phase plate 29. Note that the viewing angle compensation plate 24 may be placed closer to the light-incident side than the microlens array 14 is The optical film 23 may include a viewing angle compensation plate.

Next, with reference to FIGS. 2(a) to 2(e) and FIGS. 3(a) to 3(d), a preferable production method for a liquid crystal display panel 10 will be described. Herein, FIGS. 2(a) to 2(e) and FIGS. 3(a) to 3(c) show steps by which a plurality of liquid crystal display panels 10 shown FIG. 1 are formed simultaneously on a single mother substrate, and FIG. 3(d) shows a step by which the plurality of liquid crystal display panels 10 formed on the mother substrate are cut off to become a plurality of liquid crystal display panels 10 which are independent from one another. Therefore, in FIGS. 2 (a) to 2 (e) and FIGS. 3(a) to 3(c), the constituent elements of the plurality of liquid crystal display panels 10, e.g., the TFT substrates 30, the counter substrates 32, the protection layers 35, the optical films 22 and 23, and the like, are each shown as one continuous layer.

First, as shown in FIG. 2(a), a liquid crystal panel 12 having a plurality of pixels in a matrix arrangement is provided. The liquid crystal panel 12 includes a TFT substrate 30, a counter substrate 32, and a liquid crystal layer 34. The liquid crystal layer 34 is formed by using a liquid crystal dropping method, and is sealed between the TFT substrate 30 and the counter substrate 32 with a sealant 36.

Although a liquid crystal injection method could be adopted for the formation of the liquid crystal layer 34, use of the liquid crystal dropping method will make it easy to simultaneously form a plurality of liquid crystal panels on a mother substrate within a short period of time. In the case where the liquid crystal injection method is adopted, liquid crystal is to be injected after the liquid crystal panel is formed. At this time, a problem of liquid crystal contamination may occur because of the microlens material or the like coming in contact with the liquid crystal. Use of the liquid crystal dropping method will also prevent such a contamination problem.

Next, as shown in FIG. 2(b), a dry film (dry resist film) is attached on one of a pair of principal faces that is on the outside of the liquid crystal panel 12, thereby forming a resin layer 39. A photocurable resin is used as the material of the resin layer 39. Although it is preferable to use a UV-curable resin having a high transmittance for the dry film (resin layer 39), a photocurable resin, a thermosetting resin, or a photocurable-thermosetting type resin can otherwise be used. In a subsequent step, microlenses 14a are formed by processing the resin layer 39. In order to realize a thin liquid crystal display device, it is desirable to make the thickness of the resin layer 39 as thin as possible.

Next, as shown in FIGS. 2(c) to 2(e), a microlens array 14 including the plurality of microlenses 14a and supports 18 are formed by processing the resin layer 39. Formation of the microlenses 14a is performed by a self alignment method described in Patent Document 3. According to this method, microlenses 14a corresponding to the respective pixels can be easily formed with no misalignment of optical axes.

Based on this method, in the step shown in FIG. 2(c), the resin layer 39 of UV-curable resin is irradiated with UV light through the liquid crystal panel 12. During the UV light irradiation, the substrate or the UV light source is moved so as to change the incident angle of the irradiation light to the liquid crystal panel 12 in a stepwise or gradual manner. As a result, the irradiation intensity of the irradiation light on the resin layer 39 is locally changed, whereby microlenses 14a corresponding to the respective pixels (latent images 14a′ of microlenses) are formed.

Thereafter, as shown in FIG. 2(d), the resin layer 39 is exposed to light from the opposite side of the liquid crystal panel 12 through a photomask 40, thereby forming supports 18 (latent images 18′ of supports) in a peripheral region of the microlens array 14.

By performing a development step after this exposure step, as shown in FIG. 2(e), the microlens array 14 having the plurality of microlenses 14a is formed, and also the supports 18 are formed in the peripheral region of the microlens array 14. Since the height of the supports 18 and the microlenses 14a can be defined by the thickness of the resin layer 39, a resin layer 39 having a high thickness uniformity can be obtained by using a dry film for the resin layer 39, thereby providing an advantage in that the height of the supports 18 and the microlenses 14a (maximum height) can be precisely controlled to the same height.

Thereafter, as shown in FIG. 3(a), the same dry film as the dry film used for forming the resin layer 39 is attached so as to be in contact with apex portions of the microlenses 14a and the supports 18, thus forming a resin layer 35′. At this time, if the attachment pressure is too high, the dry film may enter into the recesses of the microlenses 14a; conversely, if it is too low, the degree of contact will decrease. Therefore, it is desirable that the attachment pressure is within a range from 0.05 to 1 MPa.

It is desirable that the temperature at which the dry film is attached is not less than 50° C. and not more than the glass transition temperature of the dry film (which is 110° C. in the present embodiment). If it is 50° C. or less, the degree of contact between the dry film and the microlenses 14a and supports 18 will decrease, and thus peeling becomes likely to occur; and if it is greater than the glass transition temperature, the dry film will be so soft that the dry film may be buried in the microlens array. Moreover, it is preferable that the speed at which the dry film is press-fitted to the microlens array 14 is within the range from 0.5 to 4 m/min. If the speed is too fast, the degree of contact will be low, and if it is too slow, the production efficiency will be deteriorated.

Next, as shown in FIG. 3(b), the resin layer 35′ is irradiated with UV light to perform a bake, whereby a protection layer 35 is formed. Since the protection layer 35 is secured to the apex portions of the microlenses 14a and the supports 18, peeling of the protection layer 35 and the optical film 22 to be formed in a substrate step and display unevenness due to deformation of the protection layer 35 are prevented.

Thereafter, as shown in FIG. 3(c), the optical film 22 on the light-outgoing side is attached to the protection layer 35 via an adhesive layer 38, and the optical film 23 on the light-incident side is attached to the liquid crystal panel 12 via an adhesive layer 37. Preferably, the optical film 22 is attached immediately after forming the protection layer 35. This will prevent the protection layer 35 from being scratched, and therefore make for an easy handling of the panel in the next step. Note that the optical film 23 can be attached to the liquid crystal panel 12 at any arbitrary point in the aforementioned steps.

Finally, as shown in FIG. 3(d), the multilayer substrate shown in FIG. 3(c) is cut, whereby a plurality of liquid crystal display panels 10 are completed.

Next, the shape of the microlenses 14a to be formed in the aforementioned steps will be described.

FIG. 4 is diagrams schematically exemplifying shapes of the microlenses 14a to be formed in the steps shown in FIGS. 2(b) to 2(d). In these steps, by adjusting the distribution of irradiation light amount for the resin layer 39, lenticular lenses each encompassing a plurality of pixel apertures (or pixels) 17 can be formed as shown in FIGS. 4(a) and 4(b), or microlens corresponding to the respective pixel apertures 17 can be formed as shown in FIGS. 4(c) to 4(e). The lens shown in FIG. 4(a) is a semicolumnar lenticular lens; and the lens shown in FIG. 4(b) is a lenticular lens having a flat portion in the neighborhood of its apex. The lenses shown in FIG. 4(c) are semicolumnar microlenses which are formed for the respective pixels; the lens shown in FIG. 4(d) is a hemispherical microlens which is formed for each pixel; and the lens shown in FIG. 4(e) is a hemispherical microlens whose apex portion is planarized.

Next, a liquid crystal display device 100 of an embodiment of the present invention, which includes the liquid crystal display panel 10, is described.

FIG. 5 is a cross-sectional view schematically showing the structure of the liquid crystal display device 100. As shown in the drawing, the liquid crystal display device 100 includes the above-described liquid crystal display panel 10 and a backlight 41 having high directivity. The backlight 41 includes a light source 42, such as an LED, a light guide plate 43 for allowing light emitted from the light source 42 to propagate therethrough and be emitted toward the liquid crystal display panel 10, and a reflector 44 for causing the light which is emitted from the rear face of the light guide plate 43 or light which is incident from outside of the liquid crystal display device 100 and transmitted through the liquid crystal display panel 10 and the light guide plate 43 to be reflected toward the light guide plate 43.

The backlight 41 emits light that has a low directivity along the direction in which LEDs used as the light source 42 are arranged and a high directivity along a direction which is orthogonal thereto. Note that directivity is an index indicating a degree of divergence (or a degree of parallelism) of light from the backlight 41, and usually an angle which results in a brightness that is half of the brightness in the frontal direction is defined as a half-directivity angle. Therefore, as this half-directivity angle becomes smaller, the backlight has more of a peak (having a high directivity) in the frontal direction.

As the backlight 41 suitable for use in the liquid crystal display device 100, for example, backlights which are described in IDW'02 “Viewing Angle Control using Optical Microstructures on Light-Guide Plate for Illumination System of Mobile Transmissive LCD Module”, K. KALANTAR, p 549-552, IDW'02 “Prism-sheetless High Bright Backlight System for Mobile Phone” A. Funamoto et al. p. 687-690, Japanese Laid-Open Patent Publication No. 2003-35824, Japanese National Phase POT Laid-Open Publication No. 8-511129, and the like are applicable.

In a direct-viewing type liquid crystal display device which is used in a mobile device, a digital still camera, or the like, a wide viewing angle needs to be obtained with the use of light which has traveled through a lens, unlike in a liquid crystal display device that is used for a projection type display device such as a projector. For this purpose, it is necessary to reduce the interval between the liquid crystal panel and the lens as much as possible, such that the light entering the lens, which is generally parallel, is deflected by about 60° at the most before outgoing therefrom.

Backlights for liquid crystal display devices include direct lighting type backlights in which a light source is placed just under a display panel, and edge light type (light guide plate type) backlights in which a light source is disposed on a side face of a light guide plate placed just under the display panel. The edge light type backlights have a relatively thin body and are therefore suitable to direct-viewing type liquid crystal display devices, of which reduction of the device size is demanded, and especially suitable to liquid crystal display devices for mobile applications, laptop computers, etc.

When a microlens array is applied to a direct-viewing type liquid crystal display device, the backlight used desirably emits light which is as near to parallel light as possible and which has high directivity, i.e., light which has high directivity in a direction vertical to the display surface. An example of such a backlight is an edge light type backlight which uses a turning lens (TL) or a reversed prism (RP).

When a liquid crystal display device which includes microlenses is used to perform high quality display, it is required that the light emitted from the backlight to the microlenses is as near to collimated light as possible such that it is vertically incident on the display surface and that the light need to be uniform without unevenness in brightness distribution.

The liquid crystal display device of this embodiment uses a reversed prism type backlight. Therefore, small part of the light obliquely travels through the liquid crystal layer, and therefore, degradation of the display quality, such as whitening, can be reduced.

### INDUSTRIAL APPLICABILITY

According to the present invention, the display performance of a VA-type liquid crystal display device, such as viewing angle characteristics, can be improved. Also, according to the present invention, the production cost of a liquid crystal display device with high reliability in which microlenses and pixels are aligned with high precision can be reduced.

1. A liquid crystal display panel, comprising:
a liquid crystal layer of a vertically aligned type;
a light-incident side substrate and a light-outgoing side substrate which oppose each other via the liquid crystal layer;
a microlens array provided on a light-outgoing side of the light-outgoing side substrate;
a first polarizing plate provided on a light-outgoing side of the microlens array; and
a second polarizing plate provided on a light-incident side of the light-incident side substrate.

2. The liquid crystal display panel of claim 1, wherein the microlens array includes a plurality of microlenses formed by irradiating a photocurable resin through pixel apertures.

3. The liquid crystal display panel of claim 1, wherein the microlens array includes a plurality of microlenses which have convex surfaces on the light-outgoing side.

4. The liquid crystal display panel of claim 1, wherein the liquid crystal display panel is a direct viewing type liquid crystal display panel.

5. The liquid crystal display panel of claim 1, further comprising a viewing angle compensation plate.

6. The liquid crystal display panel of claim 5, wherein the viewing angle compensation plate is provided on the light-outgoing side of the microlens array.

7. The liquid crystal display panel of claim 5, wherein the viewing angle compensation plate is provided on the light-incident side of the microlens array.

8. The liquid crystal display panel of claim 5, wherein the first polarizing plate is provided on the light-outgoing side of the viewing angle compensation plate.

9. The liquid crystal display panel of claim 1, further comprising a phase plate on the light-outgoing side of the microlens array.

10. The liquid crystal display panel of claim 9, wherein the phase plate is provided between the viewing angle compensation plate and the first polarizing plate.

11. A liquid crystal display device, comprising:
the liquid crystal display panel as recited in claim 1; and
a backlight provided on the light-incident side of the liquid crystal display panel.

12. The liquid crystal display device of claim 11, wherein the backlight includes
a light guide plate configured to guide light emitted from a light source;
a reflector configured to reflect the light originating from the light source toward the liquid crystal display panel; and
a plurality of prisms of a reversed prism type which are provided between the light guide plate and the liquid crystal panel.

13. A method for producing a liquid crystal display panel, comprising the steps of:
forming a microlens array on a light-outgoing side of a light-outgoing side substrate that opposes a light-incident side substrate via a vertically aligned type liquid crystal layer;
placing a first polarizing plate on the light-outgoing side of the microlens array; and
placing a second polarizing plate on a light-incident side of the light-incident side substrate.

14. The method of claim 13, wherein the microlens array is formed by irradiating a photocurable resin through pixel apertures.

15. The method of claim 13, wherein the microlens array is formed so as to have convex surfaces on the light-outgoing side.

16. The method of any one of claim 13, further comprising the step of placing a viewing angle compensation plate.

17. The method of claim 16, wherein the viewing angle compensation plate is placed on the light-outgoing side of the microlens array.

18. The method of claim 16, wherein the viewing angle compensation plate is placed on the light-incident side of the microlens array.

19. The method of claim 16, any one of claims 16, further comprising the step of placing a phase plate on a light-outgoing side of the viewing angle compensation plate.
